(19) United States
(12) Patent Application Publication
(10) Pub. No.: US 2014/0325225 A1
(43) Pub. Date: Oct. 30, 2014

(54) Self-authenticated method with timestamp

(71) Applicant: Quantron Inc., San Francisco, CA (US)

(72) Inventors: Li Liu, San Francisco, CA (US); Steve Yi long Chao, San Francisco, CA (US); Chenggong Yang, San Francisco, CA (US)

(73) Assignee: Quantron Inc., San Francisco, CA (US)

(21) Appl. No.: 13/872,102

(22) Filed: Apr. 27, 2013

(51) Int. Cl. H04L 9/32

(52) U.S. Cl. CPC H04L 9/3297
USPC 713/171

(57) ABSTRACT

A self-authenticated method with timestamp consists of key generating process and self-authenticated process between sender and receiver. The key generating center generates public key generator and private key according to sender's ID; combines the ID of the key generating center and the applied valid time of the sender to generate a identity of the key generating center with timestamp, and generating the corresponding coupled public and private keys; encrypting sender's ID and timestamp by using the private key of the coupled public and private keys, and obtains the first ciphertext of the sender's ID valid period; key generating center packs the sender's valid period, ID plaintext, first ciphertext of ID valid period, sender's public key generator and private key as a tool kit, and send the tool kit key to the sender; the sender encrypts its own ID and valid period by using sender's private key, to form the second ciphertext of the ID valid period, then sends the plaintext of the valid period, the second ciphertext and the first ciphertext of the ID valid period to the receiver; at the same time, performs valid period authentication and identity authentication. The present invention solves the problem in the existing self-authenticated system that the system cannot define valid period of a user's key.

### FIELD OF THE INVENTION

The present invention relates to an authentication method for data communication, especially a self-authenticated method with timestamp, and associated data encrypting and decrypting methods, mutual self-authenticated of communicators, and renewal of self-authentication.

### BACKGROUND OF THE INVENTION

Cloud computing shares resources and services, such as dispersive information, software and hardware platforms, through internet and virtualization technologies, which provides dynamic warping service to users following market demand. Users obtain resource from service provider through terminal, especially mobile terminal. The traditional challenge of private data security eventually becomes more significant, due to the complicated structure and co-share feature of cloud computing. Data encryption and authentication are the current key techniques for the security of vast data during cloud computing. The data encrypting methods are thus emerged by the growing demand of data security.

Data encryption and decryption are commonly applied methods for data security. Data encryption converts plaintext into ciphertext by encryption algorithm and key, whereas decryption converts ciphertext into plaintext. Encryption technique is classified into Symmetric Cryptography Algorithms and Asymmetric Cryptography Algorithms. Symmetric encryption means that users encrypt and decrypt data by using the same password. The password is a command, controlling the encrypting and decrypting processes. Algorithm is a set of rules, determining how to encrypt and decrypt. Therefore, symmetric encryption is not safe by itself. Asymmetric encrypting method overcomes the challenge of key transfer, by applying different keys during encrypting and decrypting.

In the asymmetric key system represented by the PKI, the public key and the authentication are achieved through the third party CA, which has systematically risk and waste of network resources. Therefore, a self-authentication is needed in mutual communication, such as the method of public key combination proposed in patent application CN201310029811.X. However, the public key combination cannot manage the valid period of physical key. The disappearance of entity makes the existence of physical key become wastes. Hence, the valid period for the physical key is applied to deal with the keys according to given rules.

Key management is the key challenge for the security of cloud computing. The communication of both parties in self-authenticated process does not rely on the third party for key generation and transmission, which not only solves the key security management, but also reduces the energy consumption for transmitting keys during cloud computing. Self-authentication is defined as an authentication and encryption process, in which the third party (e.g. CA center) is not required in the process of key exchange. Both sender and receiver can determine the corresponding public keys based on the public identity provided by the counter party and verify the private key signature of the counter party. In addition, a user can determine the public key according to the public identity provided by any other users, and use the public key for data encrypting and transmitting, to realize sharing and transmitting data between particular users. During these processes, the third party is excluded from acquiring the public key, which reduces the network resource consumption and improves the security of data encryption and authorization.

The generation process of self-authenticated key is shown in FIG. 1. The entity transmits its unique identity information to key generating center (KGC) and KGC manipulates certain conversion to generate user's private key (shown in FIG. 1). When transmitting private key to the entity, the key generating center sends public key generator to the entity at the same time. By acquiring the other user's unique identity information, the user can generate the public key through public key generator, i.e., the public key is obtain by self-authentication, rather than the third party.

The self-authenticated process is shown in FIG. 2:

(1) User Alice uses her private key and ID for encryption, to form information with Alice's signature, namely signature code;
(2) Alice's signature code is transmitted to user Bob through the network. Bob checks Alice's public key according to Alice's public identity and unique ID and accomplishes authentication of signature code by using public key;
(3) The authenticator is successful if information m is restored, otherwise it fails.
The self-authenticated key encrypts and decrypts data:
The encryption and decryption of self-authenticated system can be achieved by combining the asymmetric and symmetric methods. Since symmetric encrypting method runs faster than asymmetric method, symmetric encryption is recommended for big data, whereas the key for encryption is encrypted and packaged by private key.
A proposed strategy is to use symmetric cryptography algorithm for data encryption using syemtric password and use asymmetric cryptography algorithm for symmetric password encryption.

Encryption process shown as FIG. 3: user Alice obtains encrypted data by using a pair of symmetric keys from the symmetrical encryptor. The pair of keys are further encrypted via Bob's ID and public key generated by public key generator by using asymmetric encryption method.

Decryption process shown as FIG. 3: user Bob's private key obtains the plaintext of encrypted key via password decryptor, i.e. password for data decryption, and the data's symmetric key works on the data decryptor to obtain the decrypted data.

This method uses user Bob's ID to generate public key via public key generator, then encrypts symmetric key by using the public key, cracks the encrypted key by using user Bob's private key, and finally obtains symmetric encrypted password of the data, and then the plaintext of data.

The self-authenticated system with timestamp is established, after adding timestamp into the ciphertext. However, the distributed key is irrevocable due to the lack of valid period, which wastes plenty of storage space and the key resources.

### SUMMARY OF THE INVENTION

The present invention aims to provide a self-authenticated system with timestamp and solve the problem of the distributed key is irrevocable in the existing self-authenticated system.

The technical scheme of the present invention is as follows: a self-authenticated method with timestamp, consisting of private key generating process and self-authenticated process between sender and receiver, wherein the self-authenticated process is conducted between sender and receiver with timestamp, which consists of valid period authentication and identity authentication; the steps are described as follows:

(1) Generating public key generator and private key by the key generating center according to sender's ID;

(2) Combining the ID of the key generating center and the application time of the sender to generate a identity of the key generating center with timestamp, and generating the corresponding coupled public and private keys;

(3) Encrypting sender's ID and timestamp by using the private key of the coupled public and private keys, and obtaining the first ciphertext of the sender's ID valid period;

(4) Packing the sender's valid period, ID plaintext, first ciphertext of ID valid period, sender's public key generator and private key as a tool kit, the key generating center sends the tool kit to the sender;

(5) The sender encrypts its own ID and valid period by using sender's private key, to form the second ciphertext of the ID valid period, then sends the plaintext of the valid period, the second ciphertext and the first ciphertext of the ID valid period to the receiver;

(6) Performing valid period authentication and identity authentication.

The time identity described in Step (2) for key generation consists of application time and expire time.

The valid period authentication described in Step (6) consists of the following processes: obtaining the application time by the receiver via decomposing the valid period and ID plaintext, then combining the application time and key generating center's ID to form an identity of the key generating center with timestamp, generating the public key by the public key generator; decrypting the first ciphertext of ID valid period delivered by the sender; if the decrypted data are consistent with the sender's valid period and the valid period of the ID plaintext, the sender's valid period is authenticated and the receiver receives the valid period; if the sender's ID is valid and the corresponding private and public keys are valid, then performing subsequent communication, otherwise the communication between the sender and the receiver is terminated when the decrypted data and valid period are inconsistent with the valid period of ID plaintext or beyond the valid period of sender's ID.

The identity authentication described in Step (6) consists of the following processes: by using the valid period and ID plaintext obtained in Step (5), the receiver obtains the sender's public key via receiver's public key generator, the receiver encrypts the second ciphertext of ID valid period by using the sender's public key; the sender's ID is authenticated when the decrypted data are consistent with the sender's valid period and the ID plaintext; otherwise, the communication between the sender and the receiver is terminated.

The present invention provides a self-authenticated method with timestamp, which solves data transmitting problem via encrypting and decrypting processes. Data loss and security risk caused by the instability of the third party are significantly reduced in the mutual self-certified system. In addition, the renewal process of authentication ensures the effectiveness of communication and avoids the waste of resources. Traditionally, the issued self-authenticated key is irrevocable. By adding the identity of valid period, the present invention allows that the issued key expires automatically, thus the key is reusable by distributing to other users. Compared with high-level entity, key always exists in the key system. In order to ensure decrypting the users' encrypted documents after the key expires, a public key never distributes to other entities even though the current entity no longer uses this key. In the low-level entities, the key repeals after expire date and can be distributed to other users.

### BRIEF DESCRIPTION OF THE DRAWINGS

FIG. 1 is the self-authenticated system of prior art;

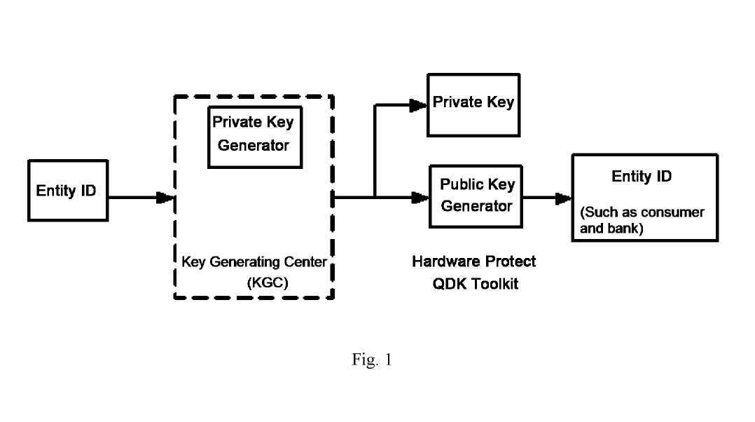

FIG. 2 is the schematic diagram of the self- certified process of the prior art;

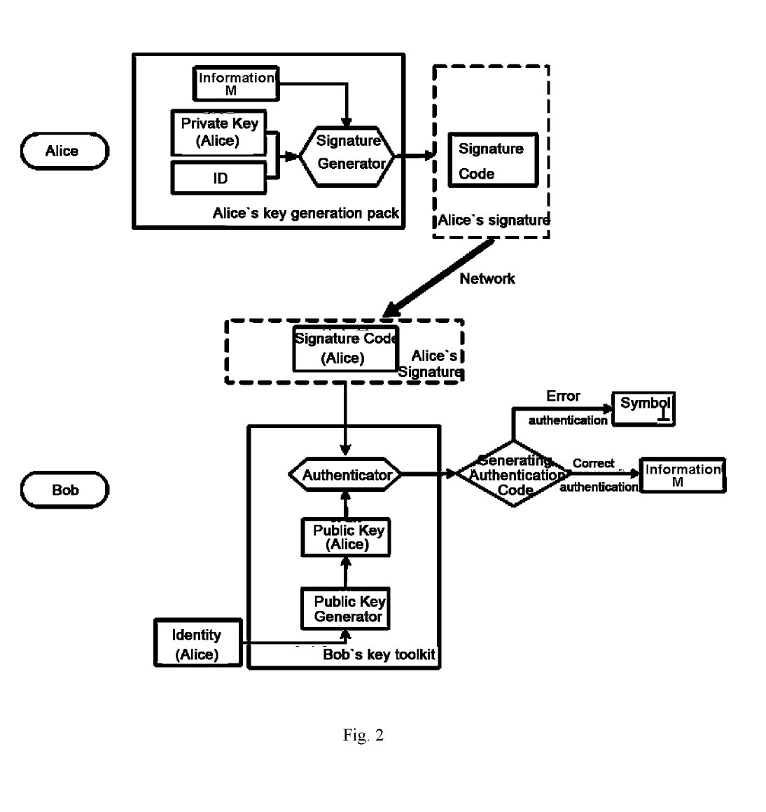

FIG. 3 is the flow chat of data encrypting and decrypting process of the prior art;

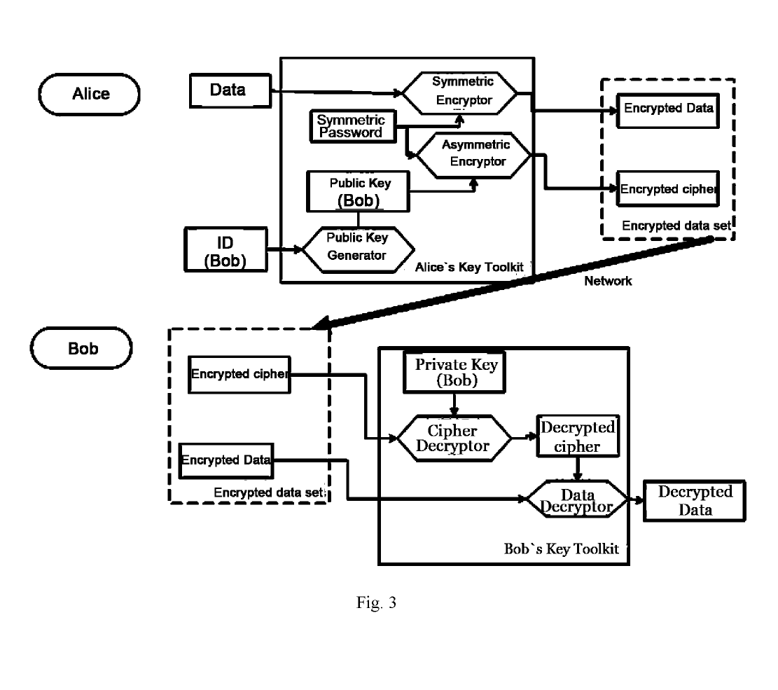

FIG. 4 is the schematic diagram of key generating process according to the invention;

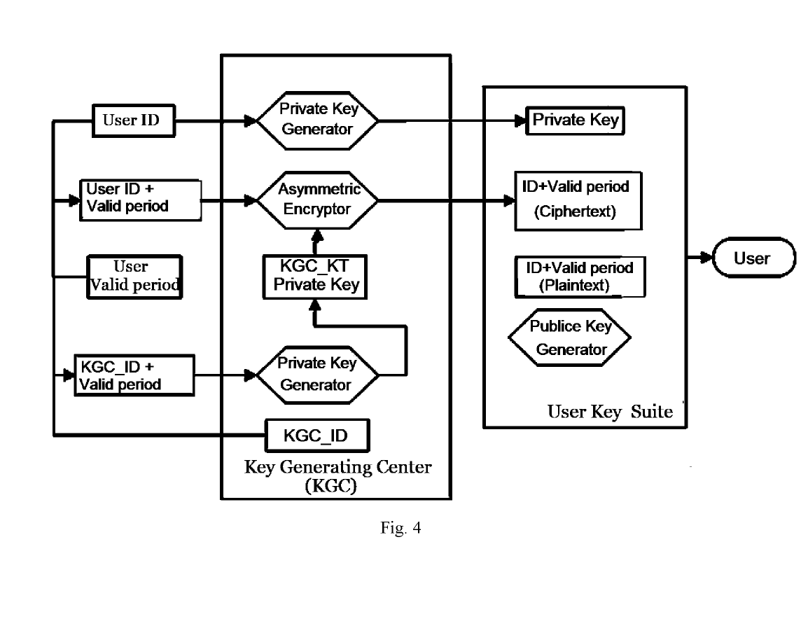

FIG. 5 is the flow chat of self-authenticated method with timestamp according to the invention.

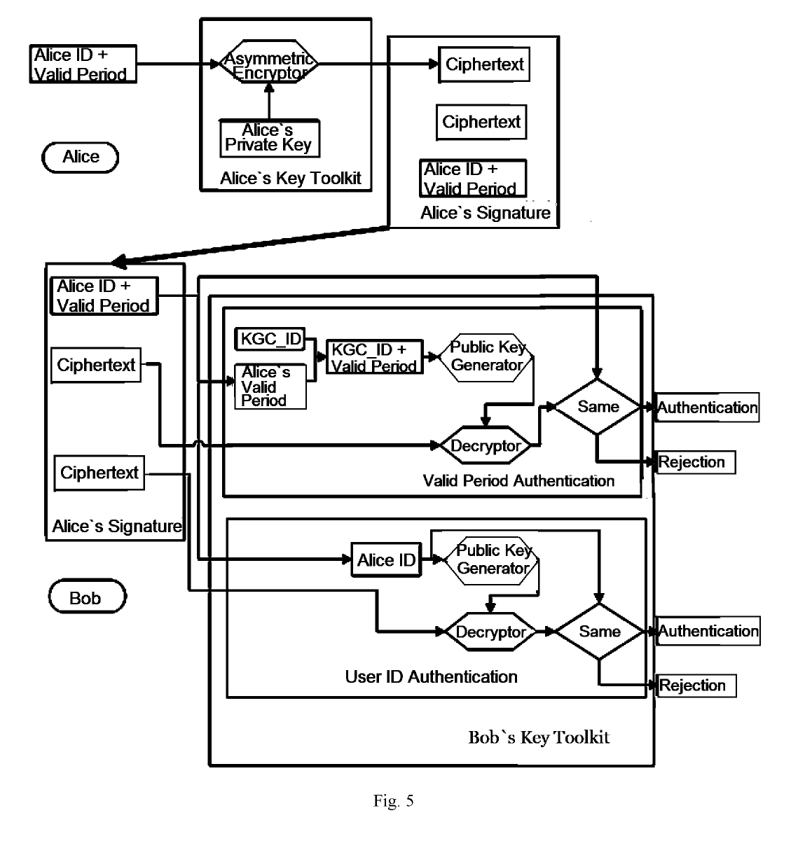

### BRIEF DESCRIPTION OF THE PREFERRED EMBODIMENTS

The self-authenticated method with timestamp is described in details hereinafter with reference to the drawings in combination with embodiments.

The present invention provides a self-authenticated method with timestamp, which uses ID and effective time period identity to generate coupled public and private keys, and uses asymmetric cryptography algorithm to encrypt ciphertext. It is similar to the existing self-authenticated method, but the valid period is incorporated into the present invention. The valid period refers to the key valid period of users. The extinction of entity makes the associated key become a waste of resource. Hence, valid period for the keys is proposed in the present invention.

The present invention provides a self-authenticated method with timestamp, consisting of private key generating process and self-authenticated process between sender and receiver, wherein the self-authenticated process is conducted between sender and receiver with timestamp, which consists of valid period authorization and identity authorization; the steps are described as follows:

(1) Generating public key generator and private key by the key generating center (KGC) according to sender's ID;

(2) Combining the ID of the key generating center and the application time of the sender to generate a identity of the key generating center with timestamp, and generating the corresponding coupled public and private keys (Key_{KT}) ;

(3) Encrypting sender's ID and timestamp, by using the private key of the coupled public and private keys, and obtaining the first ciphertext of the valid period of the sender's ID;

(4) Packing the sender's valid period, ID plaintext, first ciphertext of ID valid period, sender's public key generator and private key as a tool kit, the key generating center sends the tool kit to the sender;

(5) The sender encrypts its own ID and valid period by using sender's private key, to form the second ciphertext of the ID's valid period, then sends the plaintext of the valid period, the second ciphertext and the first ciphertext of the ID's valid period to the receiver;

(6) Performing valid period authentication and identity authentication.

The valid period authentication consists of the following processes: obtaining the application time by the receiver via decomposing the valid period and plaintext, then combining the application time and key generating center's ID to form an identity of the key generating center with timestamp, generating the public key by the public key generator; decrypting the first ciphertext of ID valid period delivered by the sender; if the decrypted data are consistent with the sender's valid period and the valid period of the ID plaintext, the sender's valid period is authenticated and the receiver receives the valid period; if the sender's ID is valid and the corresponding private and public keys are valid, then performing subsequent communication, otherwise the communication between the sender and the receiver is terminated when the decrypted data and valid period are inconsistent with the valid period of ID plaintext or beyond the valid period of sender's ID.

The identity authentication consists of the following processes: by using the valid period and plaintext obtained in Step (5), the receiver obtains the sender's public key via receiver's public key generator, the receiver encrypts the second ciphertext of ID valid period by using the sender's public key; the sender's ID is authenticated when the decrypted data are consistent with the sender's valid period and the ID plaintext; otherwise, the communication between the sender and the receiver is terminated.

Using the two methods stated above, the self-authentication of key with valid period is achieved. When a user's key is expired, the system refuses authentication and the key is automatically expired, and the expired key can be distributed to other users.

For scheduling the valid period of users' key, the KGC of the present invention schedules the valid period of users' key in advance according to users' application or the specific regulations of KGC. The system time is calibrated according to the standard time which is calibrated by Beidou Satellite, ratio wave of observatory, GPS and so on, to accomplish a time consistency of all users.

Generally speaking, the self-authenticated method with timestamp inserts time element for each user, which allows keys to be activated or terminated. This solves the problem that the issued key is irrevocable in the traditional self-authenticated system.

What is claimed is:

1. A self-authenticated method with timestamp, consisting of key generating process and self-authenticated process between sender and receiver, wherein the self-authenticated process is conducted between sender and receiver with timestamp, which consists of valid period authentication and identity authentication; the specific steps are described as follows:
Generating public key generator and private key by the key generating center according to sender's ID;
Combining the ID of the key generating center and the application time of the sender to generate a identity of the key generating center with timestamp, and generating the corresponding coupled public and private keys (Key_{KT}) ;
Encrypting sender's ID and timestamp by using the private key of the coupled public and private keys, and obtaining the first ciphertext of the sender's ID valid period;
Packing the sender's valid period, ID plaintext, first ciphertext of ID valid period, sender's public key generator and private key as a tool kit, the key generating center sends the tool kit to the sender;
The sender encrypts its own ID and valid period by using sender's private key, to form the second ciphertext of the ID valid period, then sends the plaintext of the valid period, the second ciphertext and the first ciphertext of the ID valid period to the receiver;
Performing valid period authentication and identity authentication.

2. The self-authenticated method with timestamp according to claim 1, wherein the time identity described in Step (2) consists of application time and expire time.

3. The self-authenticated method with timestamp according to claim 1, wherein the valid period authentication described in Step (6) consists of the following processes: obtaining the application time by the receiver via decomposing the valid period and ID plaintext, then combining the application time and key generating center's ID to form an identity of the key generating center with timestamp, generating the public key by the public key generator; decrypting the first ciphertext of ID valid period delivered by the sender; if the decrypted data are consistent with the sender's valid period and the valid period of the ID plaintext, the sender's valid period is authenticated and the receiver receives the valid period; if the sender's ID is valid and the corresponding private and public keys are valid, then performing subsequent communication, otherwise the communication between the sender and the receiver is terminated when the decrypted data and valid period are inconsistent with the valid period of ID plaintext or beyond the valid period of sender's ID.

4. The self-authenticated method with timestamp according to claim 1, wherein the identity authentication described in Step (6) consists of the following processes: by using the valid period and ID plaintext obtained in Step (5), the receiver obtains the sender's public key via receiver's public key generator, the receiver encrypts the second ciphertext of ID valid period by using the sender's public key; the sender's ID is authenticated when the decrypted data are consistent with the sender's valid period and the ID plaintext; otherwise, the communication between the sender and the receiver is terminated.
